(19) United States
(12) Patent Application Publication
(10) Pub. No.: US 2026/0048452 A1
(43) Pub. Date: Feb. 19, 2026

(54) LASER WELDING DEVICE FOR LARGE DIAMETER PIPES

(71) Applicant: GENII IDEAS Co., Ltd., HSINCHU CITY (TW)

(72) Inventors: KUO CHIANG TSENG, HSINCHU CITY (TW); CHIH YU WENG, HSINCHU CITY (TW); PEI YU WANG, HSINCHU CITY (TW); TZU WEN SUNG, HSINCHU CITY (TW); FENG CHI WEI, HUALIEN CITY (TW)

(21) Appl. No.: 19/006,673

(22) Filed: Dec. 31, 2024

(30) Foreign Application Priority Data
Aug. 14, 2024 (TW) 113208754

(51) Int. Cl. B23K 26/282

(52) U.S. Cl. CPC B23K 26/282

(57) ABSTRACT

A laser welding device for large-diameter pipes includes a hanging unit which consists of two semi-circular pieces. A rotary displacement unit includes a gear. A welding unit includes a welding gun and a fixed base. The welding gun is connected to the fixed base, and the rotary displacement unit is connected to the fixed base. By hanging the hanging unit on a first workpiece, and butt-joining a second workpiece to the first workpiece, the rotary displacement unit drives the welding unit, enabling the rotary displacement unit and the welding unit to rotate circumferentially along the q arc-shaped rack bars of the hanging unit to perform pipe welding.

### BACKGROUND OF THE INVENTION

### 1. Fields of the Invention

The present invention relates to the field of laser welding, and more particularly, to a laser welding device suitable for large-diameter pipes.

### 2. Descriptions of Related Art

Referring to FIG. 8 and Taiwan Patent No. TW202346015A “Automated Auxiliary Welding Equipment,” the conventional laser welding machine 9 performs welding operations through laser energy. The conventional laser welding machine 9 uses a laser generator to produce a beam, which undergoes beam expansion, reflection, and focusing before being radiated onto the surface of a workpiece 91. The surface heat conducts through the workpiece, causing it to melt and form a specific weld pool, thus achieving laser welding of the workpiece 91.

However, this conventional laser welding machine 9 uses a linkage assembly 92 connected to the machine, which moves up and down, forward and backward, and left and right through this linkage assembly 92, creating three-dimensional position and angle changes. The linkage assembly 92 has a laser gun 93 attached at its end. When the linkage assembly 92 moves, it can easily affect the laser gun 93, causing it to shake during welding operations, resulting in inaccurate welding or misalignment. Moreover, this conventional laser welding machine 9 is not suitable for processing large-diameter pipes.

Furthermore, the larger the workpiece 91, the larger the corresponding conventional laser welding machine 9 needs to be. This leads to increased costs in manufacturing, transportation, and space requirements. Therefore, there is a need for improvement.

The present invention intends to provide a laser welding device for large diameter pipes to eliminate the shortcomings mentioned above.

### SUMMARY OF THE INVENTION

The present invention relates to a laser welding device for large-diameter pipes, and comprises a hanging unit including two semi-circular pieces which are connected to each other. The two semi-circular pieces are connected with two arc-shaped rack bars. A rotary displacement unit includes a motor connected to a gear. The gear is connected to the two arc-shaped rack bars of the hanging unit. A welding unit includes a welding gun and a fixed base. The welding gun is connected to the fixed base. The rotary displacement unit is connected to the fixed base By mounting the hanging unit to a first workpiece, and butt-joining a second workpiece to the first workpiece, the rotary displacement unit drives the welding unit. The rotary displacement unit and the welding unit rotate circumferentially along the two arc-shaped rack bars of the hanging unit to perform butt welding of the first workpiece and the second workpiece.

Preferably, two ring latches are respectively located to two connecting ends of the two semi-circular pieces of the hanging unit. The two ring latches are connected to each other to connect the two semi-circular pieces to form a closed circle, so that the two semi-circular pieces are mounted to the first workpiece.

Preferably, a first guide groove is formed to one side surface of the two semi-circular pieces of the hanging unit, and a second guide groove is formed to the other side surface of the two semi-circular pieces.

Preferably, the fixed base of the welding unit has a first guide post and a second guide post. The first guide post corresponds to the first guide groove of the two semi-circular pieces, and the second guide post corresponds to the second guide groove of the two semi-circular pieces.

Preferably, the motor is connected to the fixed base of the welding unit.

Preferably, the welding unit rotates one complete circle around a center point set by the two semi-circular pieces of the hanging unit to perform butt welding by the rotary displacement unit.

Preferably, two support assemblies are respectively connected beneath the first workpiece and the second workpiece.

Preferably, each support assembly includes four pillars and a frame base. Each pillar has a wheel set at a top end thereof.

Preferably, the welding gun of the welding unit is aligned with a joint between the first workpiece and the second workpiece.

The present invention uses the hanging unit to mount the welding unit on the first workpiece, then positions the second workpiece flush against the end face of the first workpiece. The rotary displacement unit is then activated to cause the welding unit to rotate around the center point while simultaneously performing welding, thereby achieving the purpose of welding large pipe components.

The hanging unit includes two semi-circular pieces which connect the two semi-circular pieces by two ring latches to fix the two semi-circular pieces to the pipe surface of the first workpiece. The welding unit together with the rotary displacement unit are connected to the hanging unit to complete the installation. The laser welding device has excellent mobility and easy assembly characteristics.

The laser welding device simplifies the welding unit, the hanging unit, and the rotary displacement unit, enabling them to be externally mounted on the surface of the first workpiece and easily removed after welding operations are complete, thereby reducing manufacturing costs.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the laser welding device for large-diameter pipes of the present invention;

FIG. 2 is an exploded perspective view of the laser welding device suitable for large-diameter pipes of the present invention;

FIG. 3 illustrates the external mounting unit connected to the first workpiece;

FIG. 4 shows the second workpiece butt-joined to the first workpiece;

FIG. 5 is a cross-sectional view of the laser welding device suitable for large-diameter pipes of the present invention;

FIG. 6 is a schematic view taken along the X direction of FIG. of the present invention;

FIG. 7 shows the displacement of the welding unit, and

FIG. 8 shows a conventional laser welding machine.

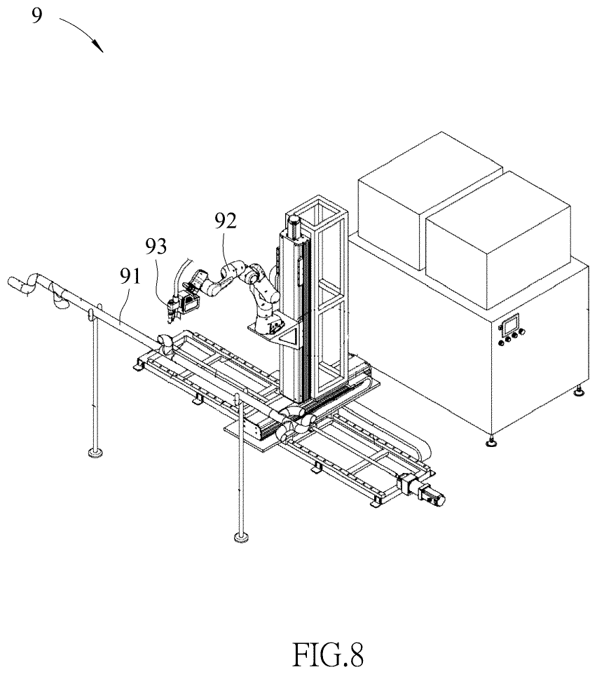

### DETAILED DESCRIPTION OF THE PREFERRED EMBODIMENT

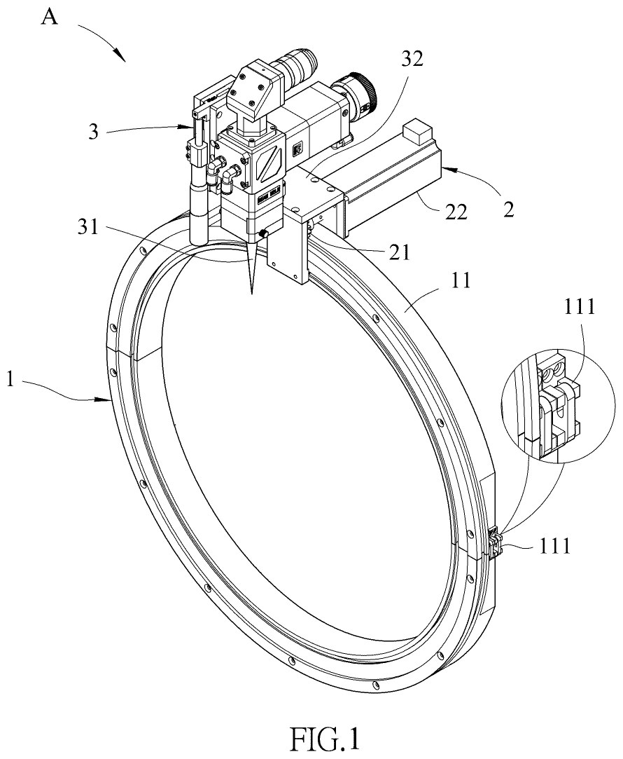

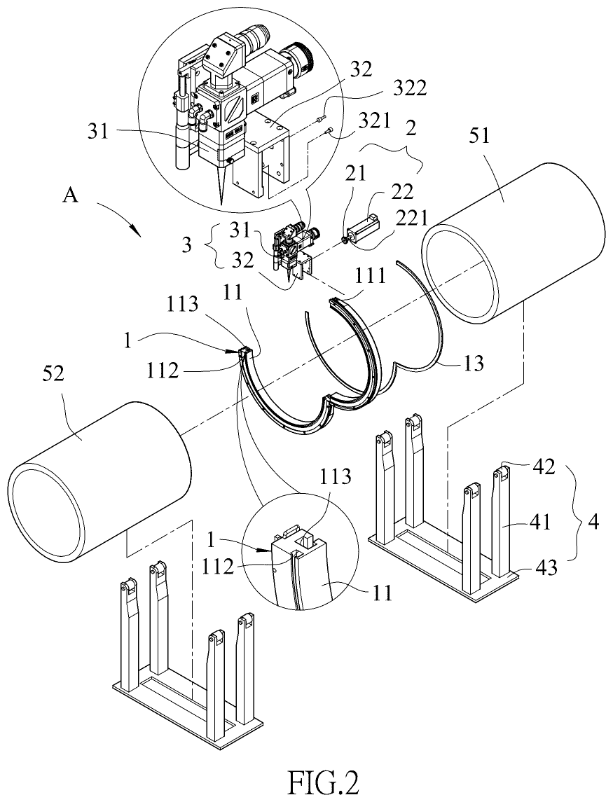

Referring to FIGS. 1 and 2, the laser welding device “A” of the present invention is suitable for welding for large-diameter pipes such as the first and second workpieces 51, 52. The laser welding device “A” of the present invention comprises a hanging unit 1, a rotary displacement unit 2, a welding unit 3 and two support assemblies 4.

The hanging unit 1 includes two semi-circular pieces 11 which are connected to each other. Two ring latches 111 are respectively located to two connecting ends of the two semi-circular pieces 11 of the hanging unit 1. The two ring latches 111 are connected to each other to connect the two semi-circular pieces 11 to form a closed circle. A first guide groove 112 is formed to one side surface of the two semi-circular pieces 11 of the hanging unit 1. A second guide groove 113 is formed to the other side surface of the two semi-circular pieces 11. The two semi-circular pieces 11 are mounted to the first workpiece 51. The two semi-circular pieces 11 are connected with two arc-shaped rack bars 13.

The rotary displacement unit 2 includes a motor 22 connected to a gear 21. The gear 21 is connected to the two arc-shaped rack bars 13 of the hanging unit 1. An output shaft 221 of the motor 22 is connected to the gear 21.

The welding unit 3 includes a welding gun 31 and a fixed base 32. The motor 22 is connected to the fixed base 32 of the welding unit 3. The welding gun 31 of the welding unit 3 is aligned with a joint between the first workpiece 51 and the second workpiece 52. The fixed base 32 of the welding unit 3 has a first guide post 321 and a second guide post 322. The first guide post 321 corresponds to the first guide groove 112 of the two semi-circular pieces 11, and the second guide post 322 corresponds to the second guide groove 113 of the two semi-circular pieces 11.

The two support assemblies 4 are respectively connected beneath the first workpiece 51 and the second workpiece 52. Each support assembly 4 includes four pillars 41 and a frame base 43. Each pillar 41 has a wheel 42 set at a top end thereof.

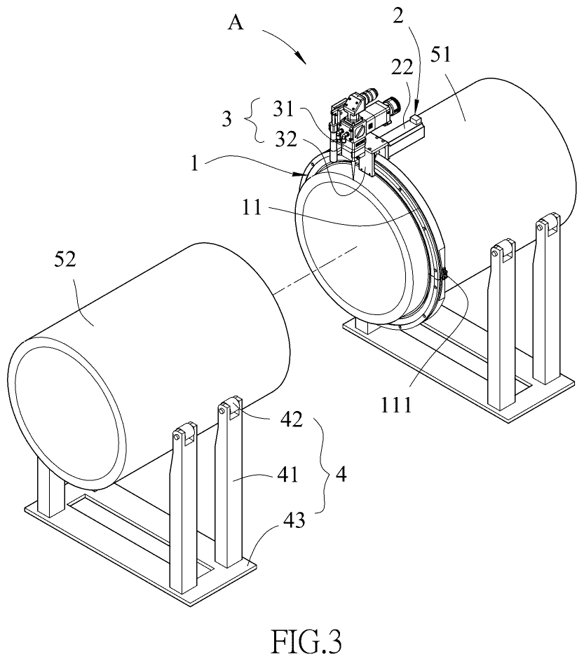

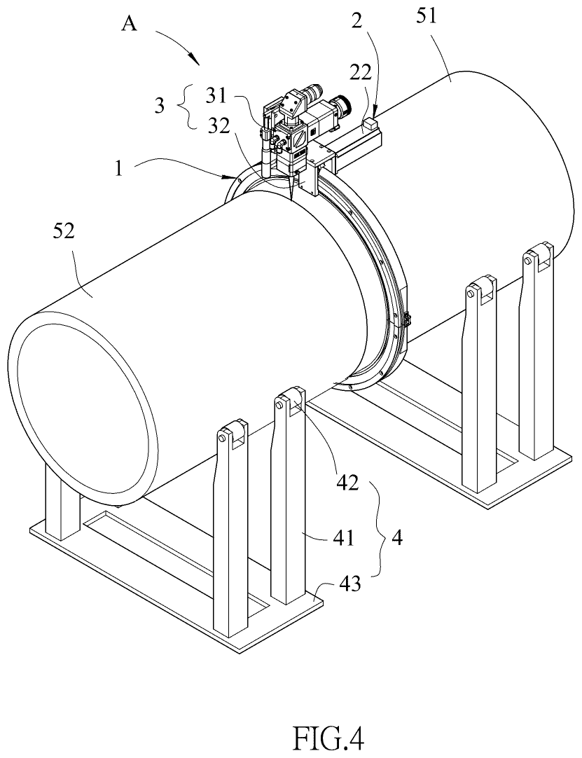

Referring to FIGS. 2 to 4, place the first workpiece 51 and the second workpiece 52 respectively on the two support assemblies 4. Regarding the size of the first workpiece 51 and the second workpiece 52, for example, the pipe diameter of 50 cm, the wheels 42 of the four pillars 41 support and fix the surface of the first workpiece 51 and the second workpiece 52 at four contact points. Then, open the two semi-circular pieces 11 of the hanging unit 1 and fit them around the circumference of the first workpiece 51. Next, slide the first guide post 321 and second guide post 322 of the fixed base 32 into the first guide groove 112 and second guide groove 113 of the two semi-circular pieces 11, while the arc-shaped rack bars 13 mesh with the gear 21, and use the two ring latches 111 to secure the two semi-circular pieces 11.

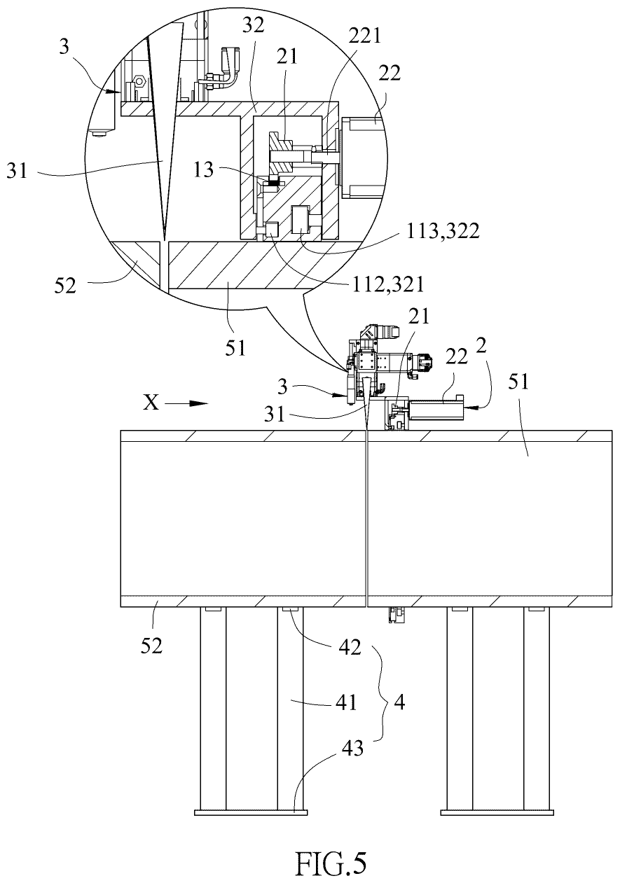

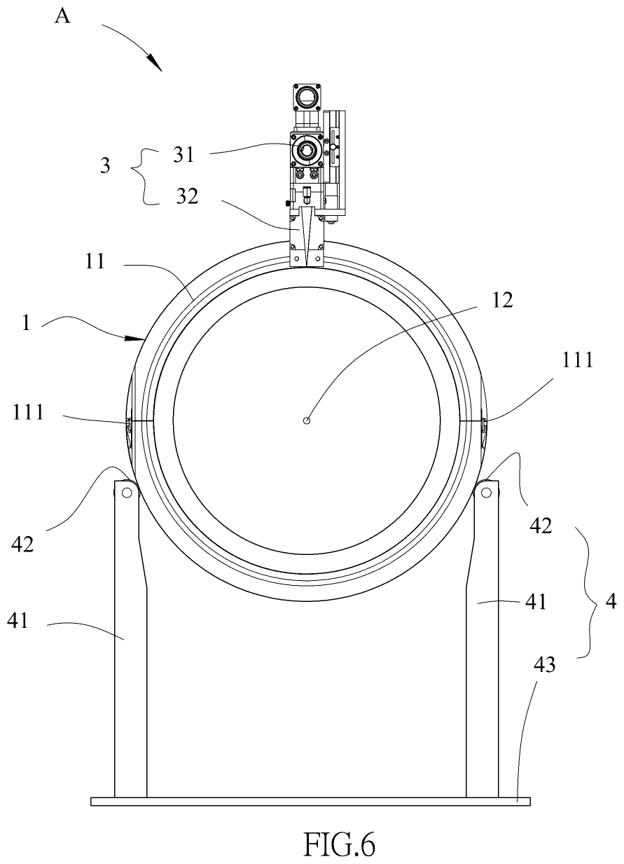

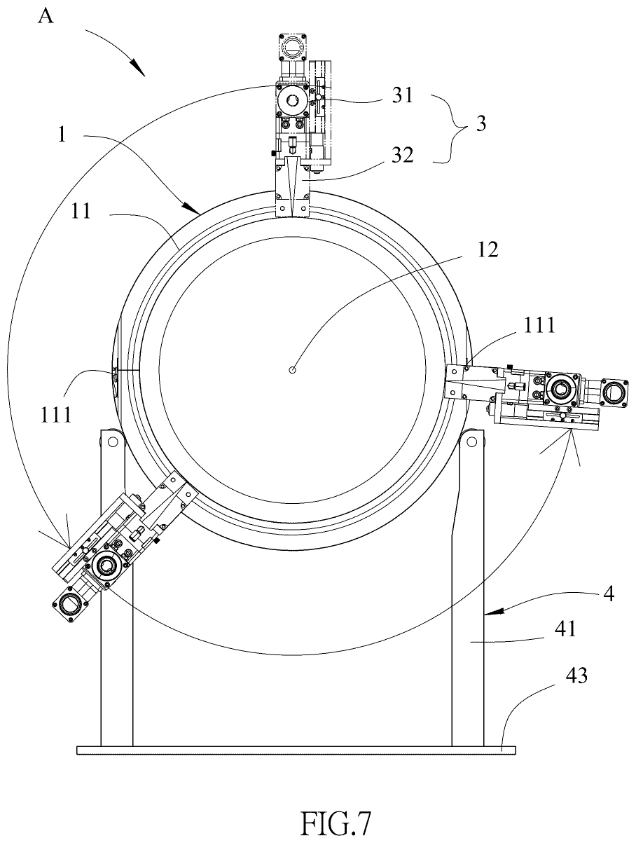

Referring to FIGS. 5 to 7, align the welding gun 31 of the welding unit 3 with the joint between the first workpiece 51 and the second workpiece 52. The operator activates the welding unit 3, and the output end 221 of the motor 22 rotates clockwise to drive the gear 21, while the gear 21 meshes and moves along the arc-shaped rack bars 13, causing the welding unit 3 to rotate one complete circle around a center point 12 set by the two semi-circular pieces 11 to perform welding of the first workpiece 51 and the second workpiece 52. When the welding unit 3 completes one rotation, the welding is finished, and the output shaft 221 of the motor 22 rotates counterclockwise to return the welding unit 3 to its original standby position to prevent electrical wires from wrapping around the first workpiece 51. The operator then removes the welding unit 3, the hanging unit 1, and the rotary displacement unit 2 from the first workpiece 51. As the welding unit 3 rotates, the first guide post 321 and the second guide post 322 are inserted into the first guide groove 112 and second guide groove 113, preventing the welding unit 3 from shaking during rotation which could cause unstable welding.

While we have shown and described the embodiment in accordance with the present invention, it should be clear to those skilled in the art that further embodiments may be made without departing from the scope of the present invention.

What is claimed is:

1. A laser welding device for large-diameter pipes, comprising:
a hanging unit 1 including two semi-circular pieces 11 which are connected to each other, the two semi-circular pieces 11 connected with two arc-shaped rack bars 13;
a rotary displacement unit 2 including a motor 22 connected to a gear 21, the gear 21 connected to the two arc-shaped rack bars 13 of the hanging unit 1, and
a welding unit 3 including a welding gun 31 and a fixed base 32, the welding gun 31 connected to the fixed base 32, the rotary displacement unit 2 connected to the fixed base 32, wherein by mounting the hanging unit 1 to a first workpiece 51, and butt-joining a second workpiece 52 to the first workpiece 51, the rotary displacement unit 2 drives the welding unit 3, the rotary displacement unit 2 and the welding unit 3 rotate circumferentially along the two arc-shaped rack bars 13 of the hanging unit 1 to perform butt welding of the first workpiece 51 and the second workpiece 52.

2. The laser welding device for large-diameter pipes as claimed in claim 1, wherein two ring latches 111 respectively located to two connecting ends of the two semi-circular pieces 11 of the hanging unit 1, the two ring latches 111 are connected to each other to connect the two semi-circular pieces 11 to form a closed circle, so that the two semi-circular pieces 11 are mounted to the first workpiece 51.

3. The laser welding device for large-diameter pipes as claimed in claim 1, wherein a first guide groove 112 is formed to one side surface of the two semi-circular pieces 11 of the hanging unit 1, a second guide groove 113 is formed to the other side surface of the two semi-circular pieces 11.

4. The laser welding device for large-diameter pipes as claimed in claim 3, wherein the fixed base 32 of the welding unit 3 has a first guide post 321 and a second guide post 322, the first guide post 321 corresponds to the first guide groove 112 of the two semi-circular pieces 11, the second guide post 322 corresponds to the second guide groove 113 of the two semi-circular pieces 11.

5. The laser welding device for large-diameter pipes as claimed in claim 1, wherein the motor 22 is connected to the fixed base 32 of the welding unit 3.

6. The laser welding device for large-diameter pipes as claimed in claim 5, wherein the welding unit 3 rotates one complete circle around a center point set by the two semi-circular pieces 11 of the hanging unit 1 to perform butt welding by the rotary displacement unit 2.

7. The laser welding device for large-diameter pipes as claimed in claim 1 further comprising two support assemblies 4 which are adapted to be respectively connected beneath the first workpiece 51 and the second workpiece 52.

8. The laser welding device for large-diameter pipes as claimed in claim 7, wherein each support assembly 4 includes four pillars 41 and a frame base 43, each pillar 41 has a wheel 42 set at a top end thereof.

9. The laser welding device for large-diameter pipes as claimed in claim 1, wherein the welding gun 31 of the welding unit 3 is adapted to be aligned with a joint between the first workpiece 51 and the second workpiece 52.
